(19) United States
(12) Patent Application Publication
(10) Pub. No.: US 2019/0168162 A1
(43) Pub. Date: Jun. 6, 2019

(54) FILTRATION ASSEMBLY AND FILTRATION SYSTEM INCLUDING THE SAME

(71) Applicant: Corning Incorporated, Corning, NY (US)

(72) Inventors: Ivan Nikolaevich Ivukin, Saint-Petersburg (RU); Nikolaos Pantelis Kladias, Horseheads, NY (US)

(21) Appl. No.: 16/200,114

(22) Filed: Nov. 26, 2018

(30) Foreign Application Priority Data
Dec. 1, 2017 (RU) PCT/RU2017/000891

(51) Int. Cl. B01D 61/18; B01D 61/20

(52) U.S. Cl. CPC B01D 61/18; B01D 61/20; B01D 2325/02; B01D 2313/08; B01D 2201/32

(57) ABSTRACT

A tangential flow filtration assembly is provided herein. The tangential flow filtration assembly includes a first and second winding tangential flow channel having an inlet at an endpoint the respective tangential flow channel and an outlet at an opposite endpoint of the respective tangential flow channel, the tangential flow channels further having a first cross-sectional area at the inlet and a second cross-sectional area at the outlet. The tangential flow filtration assembly further includes a filtration membrane positioned between the first and second tangential flow channels. The first cross-sectional area of the first tangential flow channel is greater than the second cross-sectional area of the first tangential flow channel, and the first cross-sectional area of the second tangential flow channel is less than the second cross-sectional area of the second tangential flow channel.

### CROSS REFERENCE TO RELATED APPLICATION

This application claims the benefit of priority under 35 U.S.C. § 1.19 of International Patent Application Serial No. PCT/RU2017/000891, filed on Dec. 1, 2017, the content of which is relied upon and incorporated herein by reference in its entirety.

### FIELD

The present disclosure generally relates to filtration assemblies and systems including such filtration assemblies. In particular, the present disclosure relates to tangential flow filtration assemblies including channels having variable height along a length of the channel.

### BACKGROUND

Tangential Flow Filtration (TFF) is a separation process that uses membranes to separate components in a liquid solution or suspension on the basis of size or molecule weight differences. Applications include concentration, clarification, and desalting of proteins and other biomolecules such as nucleotides, antigens, and monoclonal antibodies; buffer exchange; process development; membrane selection studies; pre-chromatographic clarification to remove colloidal particles; depyrogenation of small molecules such as dextrose and antibiotics; harvesting, washing or clarification of cell cultures, lysates, colloidal suspensions and viral cultures; and sample preparation.

One reason for the development of TFF was to provide a solution to the problem of membrane blockage associated with the various conventional filtration techniques. In TFF, the solution or suspension to be filtered is passed across the surface of the membrane in a cross-flow mode. The driving force for filtration is the transmembrane pressure, usually created with a peristaltic pump. The velocity at which the filtrate is passed through the membrane surface also controls the filtration rate and helps prevent clogging of the membrane. Because TFF recirculates retentate across the membrane surface, membrane fouling is minimized, a high filtration rate is maintained, and product recovery is enhanced.

Conventional TFF devices are formed of a plurality of elements, including a pump, a feed solution reservoir, a filtration assembly and conduits for connecting these elements. Some filtration assembly designs include straight parallel channels positioned on either side of a membrane. Other filtration assembly designs include winding channels positioned on either side of a membrane. In contrast to the straight channels, such winding channels allow filtration to be performed in a smaller footprint. Additionally, such winding channels may expose the solution or suspension to be filtered to a larger membrane surface area for a longer period of time. This in turn facilitates performing efficient filtration at low tangential velocities which may prevent damage to components in the solution or suspension to be filtered, such as cells, cell growth surfaces such as microcarriers, biomolecules, etc. The winding channels also force the flow of the solution or suspension to be filtered back and forth in a manner that creates turbulence which has been described as having a self-cleaning effect on the membrane surface. However, because of the large aspect ratio of the channels, the solution or suspension to be filtered within the channel experiences a flow resistance high enough to cause non-uniform transmembrane pressure along the length of the channel, which may in turn contribute to membrane clogging.

### SUMMARY

According to an embodiment of the present disclosure, a tangential flow filtration assembly is provided. The tangential flow filtration assembly includes a first winding tangential flow channel comprising an inlet at an endpoint of the first tangential flow channel and an outlet at an opposite endpoint of the first tangential flow channel, the first tangential flow channel further comprising a first cross-sectional area at the inlet and a second cross-sectional area at the outlet. The tangential flow filtration assembly also includes a second winding tangential flow channel comprising an inlet at an endpoint of the second tangential flow channel and an outlet at an opposite endpoint of the second tangential flow channel the second tangential flow channel further comprising a first cross-sectional area at the inlet and a second cross-sectional area at the outlet. The tangential flow filtration assembly further includes a filtration membrane positioned between the first and second tangential flow channels. The first cross-sectional area of the first tangential flow channel is greater than the second cross-sectional area of the first tangential flow channel, and the first cross-sectional area of the second tangential flow channel is less than the second cross-sectional area of the second tangential flow channel.

According to an embodiment of the present disclosure, a tangential flow filtration system is provided. The tangential flow filtration system includes a plurality of tangential flow filtration assemblies and at least one conduit fluidly connecting one of the plurality of tangential flow filtration assemblies to a subsequent assembly of the plurality of tangential flow filtration assemblies. The system includes n-1 conduits, wherein n is the number of tangential flow filtration assemblies in the plurality of tangential flow filtration assemblies. Each tangential flow filtration assembly includes a first winding tangential flow channel comprising an inlet at an endpoint of the first tangential flow channel and an outlet at an opposite endpoint of the first tangential flow channel, the first tangential flow channel further comprising a first cross-sectional area at the inlet and a second cross-sectional area at the outlet. The tangential flow filtration assembly also includes a second winding tangential flow channel comprising an inlet at an endpoint of the second tangential flow channel and an outlet at an opposite endpoint of the second tangential flow channel the second tangential flow channel further comprising a first cross-sectional area at the inlet and a second cross-sectional area at the outlet. The tangential flow filtration assembly further includes a filtration membrane positioned between the first and second tangential flow channels. The first cross-sectional area of the first tangential flow channel is greater than the second cross-sectional area of the first tangential flow channel, and the first cross-sectional area of the second tangential flow channel is less than the second cross-sectional area of the second tangential flow channel.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The disclosure will be understood more clearly from the following description and from the accompanying figures, given purely by way of non-limiting example, in which:

FIG. 1 illustrates a conventional TFF assembly;

FIG. 2 illustrates a sectional view of the TFF assembly of FIG. 1;

FIG. 3 illustrates a perspective view of the TFF assembly of FIG. 1;

FIG. 4a illustrates a TFF assembly in accordance with embodiments of the present disclosure;

FIG. 4b illustrates a side view of a tangential flow channel of the TFF assembly of FIG. 4a in accordance with embodiments of the present disclosure;

FIG. 5a shows the transmembrane velocity distribution in an exemplary cross section of a tangential flow channel of a conventional filtration assembly;

FIG. 5b shows the transmembrane velocity distribution in an exemplary cross section of a tangential flow channel of a TFF assembly in accordance with embodiments of the present disclosure;

FIG. 6 is a graph showing the transmembrane pressure along the length of the two channels of a conventional TFF assembly and along the length of the two channels of a TFF assembly in accordance with embodiments of the present disclosure; and

FIG. 7 illustrates a system including a plurality of TFF assemblies connected in series in accordance with embodiments of the present disclosure.

### DETAILED DESCRIPTION

Reference will now be made in detail to the present embodiment(s), an example(s) of which is/are illustrated in the accompanying drawings. Whenever possible, the same reference numerals will be used throughout the drawings to refer to the same or like parts.

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

As used herein, “have,” “having,” “include,” “including,” “comprise,” “comprising” or the like are used in their open ended sense, and generally mean “including, but not limited to.”

All scientific and technical terms used herein have meanings commonly used in the art unless otherwise specified. The definitions provided herein are to facilitate understanding of certain terms used frequently herein and are not meant to limit the scope of the present disclosure.

The present disclosure is described below, at first generally, then in detail on the basis of several exemplary embodiments. The features shown in combination with one another in the individual exemplary embodiments do not all have to be realized. In particular, individual features may also be omitted or combined in some other way with other features shown of the same exemplary embodiment or else of other exemplary embodiments.

Embodiments of the present disclosure relate to filtration assemblies and Tangential Flow Filtration (TFF) assemblies and systems that include such filtration assemblies. The filtration assemblies as described herein include winding channels having variable heights through the entire length of the channels. Such variable heights facilitate more uniform transmembrane pressure distribution across the membrane of the TFF assembly, which in turn reduces the likelihood of the membrane becoming clogged or otherwise experiencing reduced filtration efficiency.

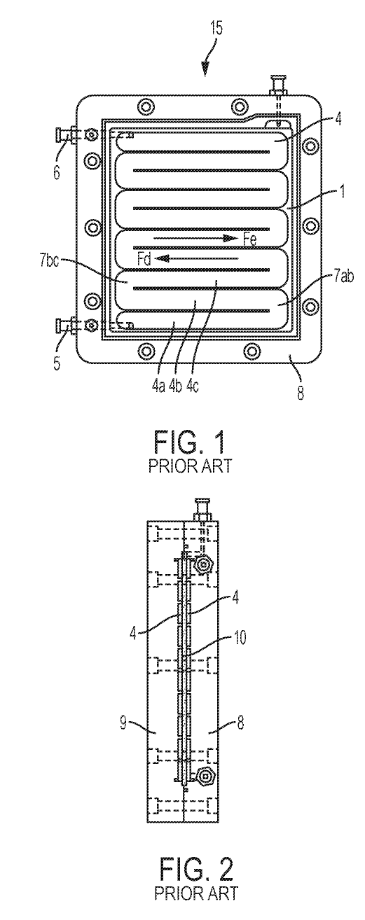

FIG. 1 illustrates a conventional TFF assembly and FIG. 2 shows a sectional view of the TFF assembly of FIG. 1. As shown the filtration assembly 15 includes a pressure resistant housing having two filtration modules 8, 9 fixed to each other. Each of the modules 8, 9 includes a tangential flow channel 4. When the modules 8, 9 are fixed to each other, the filtration assembly 15 includes two tangential flow channels 4 arranged on either side of a filtration element 10. The filtration element 10 includes two filtration membranes 1 arranged on either side of a sheet of porous material in sandwich construction. The membranes mounted on the porous material define a feed side which contacts a sample solution and a permeate side positioned in contact with the porous support material. An inlet 5 and an outlet 6 for communicating a sample solution are arranged in the housing and are fluidly connected to the tangential flow channels 4.

The tangential flow channels 4 are winding channels which, as shown in FIG. 1, include a number of straight channel sections 4a, 4b, 4c etc. separated by bent transitional zones 7ab, 7bc, 7cd, etc., where the bent transitional zones 7ab, 7bc, 7cd, etc. fluidly connect a straight channel section 4a, 4b, 4c, etc. with a subsequent straight channel section 4a, 4b, 4c, etc. The channel sections 4a, 4b, 4c, etc. and the bent transitional zones 7ab, 7bc, 7cd, etc. are arranged such that a sample solution flowing from the inlet 5 to the outlet 6 changes direction by 180° when the sample solution flows through a bent transitional zone 7ab, 7bc, 7cd, etc. from a first straight channel section 4a, 4b, 4c, etc. to a subsequent straight channel section 4a, 4b, 4c, etc.

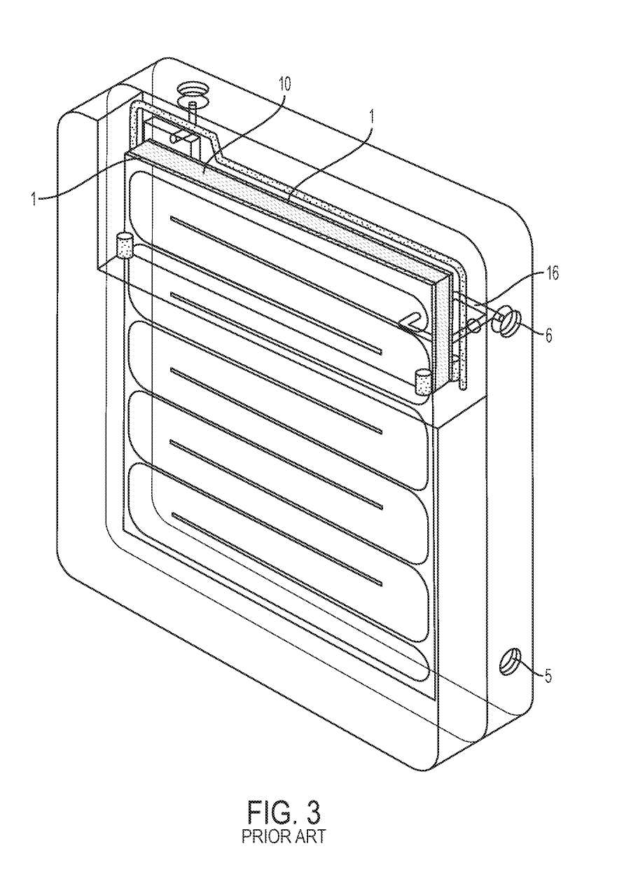

FIG. 3 illustrates a perspective view of the filtration assembly of FIG. 1 and shows the arrangement of the two filter membranes of the filtration element in a sandwich construction. FIG. 3 shows one of the tangential flow channels 4 of one of the filtration modules 8, 9 in contact with a side of one of the filtration membranes 1. As also shown, the outlet 6 is fluidly connected to the tangential flow channel 4 at an endpoint of the tangential flow channel 4 through an outlet channel 16. Similarly, the inlet 5 is also fluidly connected to the one of the tangential flow channel 4 at the opposite endpoint of the tangential flow channel 5 through an inlet channel (not shown).

FIGS. 2 and 3 further show that the conventional filtration assemblies as described herein include a height of the tangential flow channels 4 that remains constant over the length of the tangential flow channels 4. As used herein with reference to tangential flow channels, the term “height” refers to the dimension of a tangential flow channel perpendicular to the plane of the filtration element of a TFF assembly.

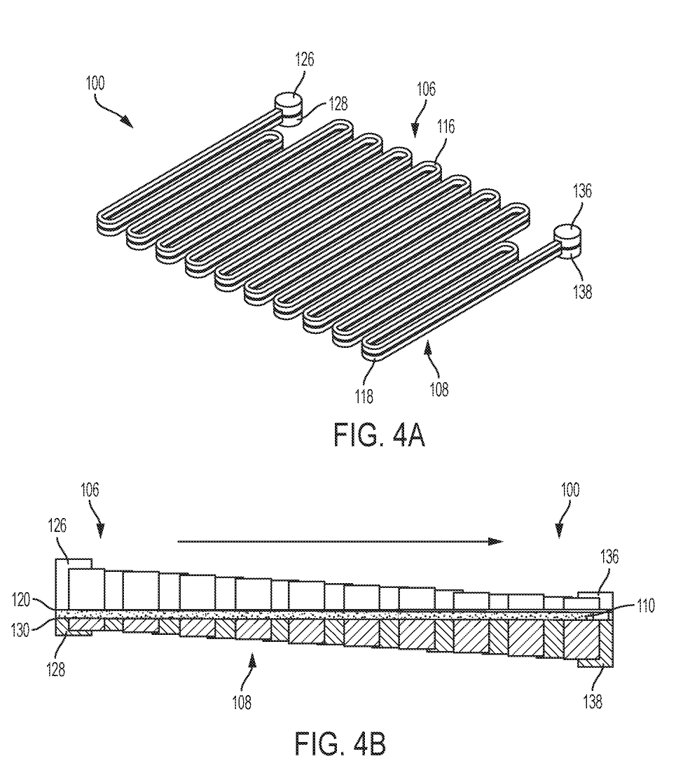

FIGS. 4a-4b illustrate a TFF assembly in accordance with embodiments of the present disclosure. The TFF assembly 100 includes a first filtration module 106 having a winding tangential flow channel 116 and a second filtration module 108 having a winding tangential flow channel 118. The first filtration module 106 includes an inlet 126 and an outlet 136 each fluidly connected to the tangential flow channel 116 at opposite endpoints of the tangential flow channel 116. Similarly, the second filtration module 108 includes an inlet 128 and an outlet 138 each fluidly connected to the tangential flow channel 118 at opposite endpoints of the tangential flow channel 118. The height of the tangential flow channels 116, 118 is variable and the tangential flow channels 116, 118 have an initial cross-sectional area at the respective inlet 126, 128 and a final cross-sectional area at the respective outlet 136, 138. According to embodiments of the present disclosure, the initial cross-sectional area of tangential flow channel 116 is greater than the final cross-sectional area of the tangential flow channel 116 and the cross-sectional area of tangential flow channel 116 reduces along the length of the channel from the inlet 126 to the outlet 136. For example, the initial cross-sectional area of tangential flow channel 116 may be between about 70% and about 95%, or between about 75% and about 90% or even between about 80% and about 85% of the total initial cross-sectional areas of both tangential flow channels 116, 118. The final cross-sectional area of tangential flow channel 116 may be between about 5% and about 30%, or between about 10% and about 25% or even between about 15% and about 20% of the total final cross-sectional areas of both tangential flow channels 116, 118. Additionally, according to embodiments of the present disclosure, the initial cross-sectional area of tangential flow channel 118 is less than the final cross-sectional area of the tangential flow channel 118 and the cross-sectional area of tangential flow channel 118 increases along the length of the channel from the inlet 128 to the outlet 138. For example, the initial cross-sectional area of tangential flow channel 118 may be between about 5% and about 30%, or between about 10% and about 25% or even between about 15% and about 20% of the total initial cross-sectional areas of both tangential flow channels 116, 118. The final cross-sectional area of tangential flow channel 118 may be between about 70% and about 95%, or between about 75% and about 90% or even between about 80% and about 85% of the total final cross-sectional areas of both tangential flow channels 116, 118.

As shown in FIGS. 4a-4b, the TFF assembly 100 includes a filtration membrane 110 positioned between, and separating, tangential flow channel 116 and tangential flow channel 118. The filtration membrane 110 is famed of a porous material and has a first surface 120 and a second surface 130. In operation of the TFF assembly 100, fluid within the tangential flow channels 116, 118 flows tangentially over opposite surfaces 120, 130 of the filtration membrane 110. The specific material and the specific pore size of the filtration membrane 110 may be selected based on the size of a species of interest that will be removed by the TFF assembly 100. As used herein, the term “species of interest” generally refers to a particle(s) or molecule(s) that is to be separated from a solution or suspension in a fluid stream, e.g., a liquid. The species are separated from the fluid stream and, in most instances, from other particles or molecules in the fluid stream. According to embodiments of the present disclosure, the species of interest are biological entities of natural biological or biochemical origin or produced by biological or biochemical processes. Like the TFF assembly shown in FIG. 3, the filtration membrane 10 may alternatively include two filtration sheets arranged on either side of a porous material in sandwich construction. The filtration sheets may be arranged in contact with, or mounted on, the porous material such that a first outer surface 120 of one of the filtration sheets contacts a fluid stream in one of the tangential flow channels 116, 118 and a first outer surface 130 of the other of the filtration sheets contacts a fluid stream in the other of the tangential flow channels 116, 118. Such filtration sheets also include second surfaces opposing the first surfaces positioned in contact with the porous material.

In operation, a first fluid stream flows into tangential flow channel 116 through inlet 126 and a second fluid stream flows into tangential flow channel 118 through inlet 128. The first fluid stream passes tangentially over the first surface 120 of the filtration membrane 110 at the same time that the second fluid stream passes tangentially over the second surface 130 of the filtration membrane 110. The first fluid stream then passes out of tangential flow channel 116 through outlet 136 and the second fluid stream passes out of tangential flow channel 118 through outlet 138 where any of the streams may be collected in a collection vessel, recirculated back to the respective inlet 126, 128 of the respective tangential flow channel 116, 118, or as will be described in greater detail below, fed to a second TFF assembly connected in series with the first TFF assembly.

One of the fluid streams includes a mixture containing a species of interest. For purposes of ease and clarity, the first fluid stream will be described herein as including a mixture containing a species of interest and will be described as flowing into and through tangential flow channel 116, while the second fluid stream will be described herein as flowing into and through tangential flow channel 118. However, it should be understood that either of the first and second streams may include a mixture containing a species of interest and either of the first and second streams may flow through either of the tangential flow channels 116, 118.

According to embodiments of the present disclosure, the pressure at which the first stream is introduced into tangential flow channel 116 at the inlet 126 and the pressure at which the first stream is removed from tangential flow channel 116 at the outlet 136 may be controlled to provide substantially constant operational pressure in tangential flow channel 116 along the length of the filtration membrane 110. Similarly, the pressure at which the second stream is introduced into tangential flow channel 118 at the inlet 128 and the pressure at which the second stream is removed from tangential flow channel 118 at the outlet 138 may be controlled to provide substantially constant operational pressure in tangential flow channel 118 along the length of the filtration membrane 110. The operational pressures in the tangential flow channels 116, 118 may be maintained such that a pressure differential between the operational pressure in tangential flow channel 116 and the operational pressure in tangential flow channel 118, or in other words, a transmembrane pressure, is applied across the filtration membrane 110.

As a result of the transmembrane pressure, as the first fluid stream and the second fluid stream flow on opposite sides of the filtration membrane 110, species small enough to pass through the pores of the filtration membrane 110 traverse the filtration membrane 110. Depending on the pore size of the material of the filtration membrane 110, species small enough to pass through pores of the filtration membrane 110 move from the first fluid stream to the second fluid stream. If larger than the pores of the material of the filtration membrane 110, the species of interest may remain in the first fluid stream in tangential flow channel 116. Alternatively, if smaller than the pores of the material of the filtration membrane 110, the species of interest may pass through the filtration membrane 110 and into the second fluid stream in tangential flow channels 118. The rate at which the species traverse the filtration membrane 110 is dependent on a number of factors including: the particular species; the constituents of the first and second fluid streams; the flow rate of the first and second fluid streams; the physical characteristics of the filtration membrane 110, the pressures in the first tangential flow channel 116 and the second tangential flow channel 118; and the temperature of the first and second fluid streams.

As species small enough to pass through pores of the filtration membrane 110 traverse the filtration membrane 110, the volume of tangential flow channel 116 occupied by the first fluid stream is effectively decreased and the volume of the tangential flow channel 118 occupied by the second fluid stream is effectively increased. Generally, the loss of volume of the first fluid stream within tangential flow channel 116 is matched by the variable height of tangential flow channel 116. Similarly, the increase of volume of the second fluid stream within tangential flow channel 118 is matched by the variable height of tangential flow channel 118. As will be described in more detail below, by compensating for the loss of the volume of the first fluid stream, the transmembrane velocity is maintained at a substantially constant rate along the entire length of the tangential flow channel 116, 118.

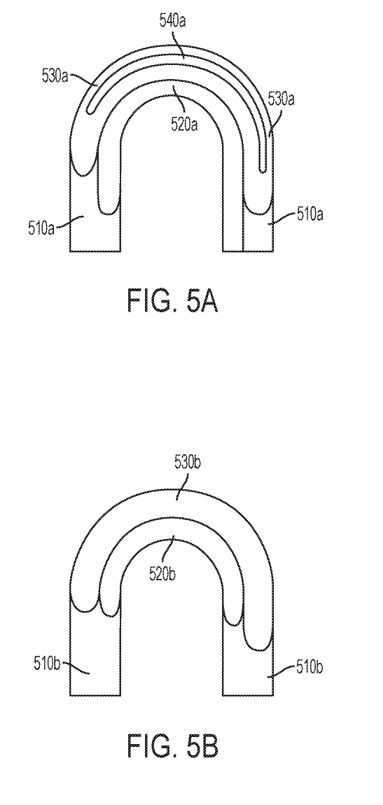

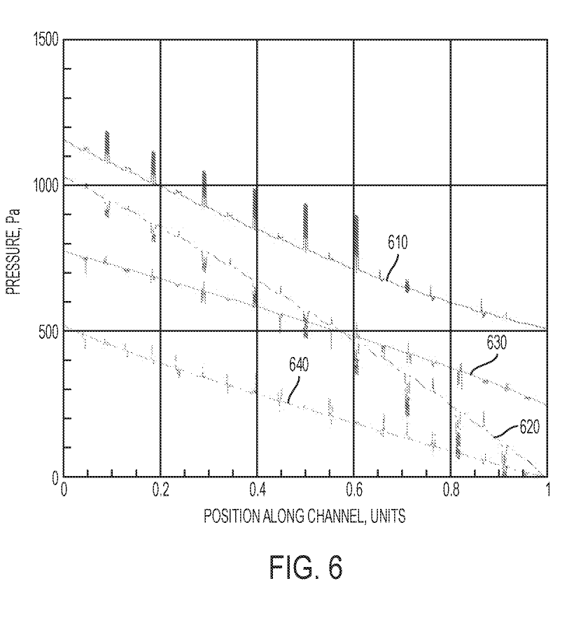

FIGS. 5a-5b and 6 show data from exemplary TFF assemblies. The conventional TFF assembly included tangential flow channels having heights that remain constant over the length of the tangential flow channels. The height of the tangential flow channels was about 2.7725 mm over the length of the tangential flow channels. The TFF assembly in accordance with embodiments of the present disclosure included tangential flow channels having variable heights over the length of the tangential flow channels. The height of a first of the tangential flow channels was about 4.545 mm at the inlet and about 1.0 mm at the outlet. The height of a second of the tangential flow channels was about 1.0 mm at the inlet and about 4.545 mm at the outlet. The filtration membrane was a polyethersulfone membrane having a thickness of about 0.11 mm and a pore size of about 5.0 μm. Flow rate of the fluid stream at the inlet was about 10 g/min.

FIG. 5a shows the transmembrane velocity distribution in an exemplary cross section of a tangential flow channel of a conventional TFF assembly. A straight channel section 4a, 4b, 4c, etc. is illustrated as being fluidly connected to a subsequent straight channel section 4a, 4b, 4c, etc, by a bent transitional zone 7ab, 7bc, 7cd, etc. Transmembrane velocity in the straight channel sections 4a, 4b, 4c, etc., defined by segments 510a, is between about 3.5×10⁻⁵ m/s and about 1.8×10⁻⁴ m/s and is substantially constant. However, in the transitional zone 7ab, 7bc, 7cd, etc. the transmembrane velocity is distributed between an inner portion of the bent transitional zone 7ab, 7bc, 7cd, etc., defined by segment 520a, and an outer portion of the bent transitional zone, defined by segments 530a and 540a. At segment 520a, the transmembrane velocity is less than or about equal to the transmembrane velocity in segment 510a in the straight channel sections 4a, 4b, 4c, etc. At segment 530a, the transmembrane velocity is greater than the transmembrane velocity in segment 510a in the straight channel sections 4a, 4b, 4c, etc. and is between about 2.5×10⁻⁴ m/s and about 6.0×10⁻⁴ m/s. At segment 540a, the transmembrane velocity reaches a maximum velocity and is between about 7.0×10⁻⁴ m/s and about 1.0×10⁻³ m/s. In one exemplary TFF assembly the transmembrane velocity at segment 540a was measured to be 9.7×10⁻³ m/s. Thus the difference between the transmembrane velocity at segment 540a and the transmembrane velocity at segment 510a is between about 5.2×10⁻⁴ m/s and about 9.6 10⁻³ Differences in the transmembrane velocity at the various segments shown in FIG. 5a may contribute to membrane clogging when the drag force, which is proportional to the transmembrane velocity, exceeds the lift force due to shear.

FIG. 5b shows the transmembrane velocity distribution in an exemplary cross section of a tangential flow channel of a TFF assembly in accordance with embodiments of the present disclosure. Like the channel shown in FIG. 5a, the transmembrane velocity in the straight channel sections, defined by segments 510b, is between about 3.5×10⁻⁵ m/s and about 1.8×10⁻⁴ m/s and is substantially constant. In the transitional zone the transmembrane velocity is distributed between an inner portion of the bent transitional zone, defined by segment 520b, and an outer portion of the bent transitional zone, defined by segment 530b. At segment 520b, the transmembrane velocity is less than or about equal to the transmembrane velocity in segment 510b in the straight channel sections. At segment 530b, the transmembrane velocity is greater than the transmembrane velocity in segment 510b in the straight channel sections and is between about 1.8×10⁻⁴ m/s and about 3.0×10⁻⁴ m/s. The transmembrane velocity reaches a maximum velocity in segment 530b. In one exemplary TFF assembly the transmembrane velocity at segment 530b was measured to be 2.9×10⁻⁴ m/s. Thus the difference between the transmembrane velocity at segment 530b and the transmembrane velocity at segment 510b is between about 0 m/s and about 2.6 10⁻⁴ m/s. As compared to the conventional TFF assembly as shown in FIG. 5a, the TFF assembly shown in FIG. 5b experiences reduced changes in transmembrane velocity throughout the entire length of the channel which in turn reduces the potential of clogging of the membrane.

FIG. 6 is a graph showing the pressures in the two channels of a conventional TFF assembly and the two channels of a TFF assembly in accordance with embodiments of the present disclosure. Shown in the graph are pressure 610 in the first channel of the conventional TFF assembly, pressure 620 in the second channel of the conventional TFF assembly, pressure 630 in the first channel of the TFF assembly in accordance with embodiments of the present disclosure, and pressure 640 in the second channel of the TFF assembly in accordance with embodiments of the present disclosure. It should be noted that the transmembrane pressure of the conventional TFF assembly is the difference between pressure 620 and pressure 610 and the transmembrane pressure of the TFF assembly in accordance with embodiments of the present disclosure is the difference between pressure 640 and pressure 630. Without limiting the various embodiments described herein, the first channel of both TFF assemblies is a retentate channel and the second channel of both TFF assemblies is a permeate channel. As used herein, the term “retentate” refers to the portion of a fluid stream that includes species that do not pass through the membrane. As used herein, the term “permeate” refers to the portion of a fluid stream that includes species that pass through the membrane. A retentate channel is distinguished from a permeate channel based on the characteristics of the fluid stream that exits the outlet of the channel; i.e., the retentate exits the outlet of the retentate channel and the permeate exits the outlet of the permeate channel.

As can be seen in the graph of FIG. 6, the pressure in the retentate channel of the TFF assembly in accordance with embodiments of the present disclosure is less than the pressure in the retentate channel of the conventional TFF assembly at all corresponding positions along the length of the channels. Similarly, with exception for the pressure at the outlet of the permeate channels where the pressures reach a similar minimum, pressure in the permeate channel of the TFF assembly in accordance with embodiments of the present disclosure is less than the pressure in the permeate channel of the conventional TFF assembly at all corresponding positions along the length of the channels. Pressure along the length of the permeate and retentate channels of the TFF assembly in accordance with the present disclosure is as much as two times less than the corresponding channels of the conventional TFF assembly. These pressure differences demonstrate that TFF assemblies in accordance with embodiments of the present disclosure advantageously reduce pump stress. Generally, the power required to pump the fluid stream through the channels can he lower and also need not be increased over time.

Another difference between the TFF assembly in accordance with embodiments of the present disclosure and the conventional TFF assembly which can be seen in FIG. 6 are reductions in pressure spikes in the retentate channel as well as corresponding drops of pressure in the permeate side at the same positions along the length of the channels. Such pressure spikes and pressure drops occur in the transitional zones of the channels and correspond to the segments of the channels where there is an increase in transmembrane velocity as illustrated in FIG. 5a. In contrast, the TFF assembly in accordance with embodiments of the present disclosure experiences large reductions in pressure spikes as compared to the conventional TFF assembly such that the channel experiences a substantially constant transmembrane pressure along the entire length of the channels.

Also as can be seen in FIG. 6, the transmembrane pressure in the conventional TFF assembly substantially increases along the length of the two channels of the assembly. Such increase in transmembrane pressure leads to inefficient and subcritical membrane load. In contrast, the transmembrane pressure of the TFF assembly in accordance with embodiments of the present disclosure remains substantially constant through the length of the two channels of the assembly. These transmembrane pressure differences demonstrate that TFF assemblies in accordance with embodiments of the present disclosure advantageously improve TFF assembly efficiency as compared to conventional TFF assemblies. Generally, because the transmembrane pressure remains substantially constant through the length of the two channels of the assembly, more fluid can be pumped through the channels without clogging of the filtration membrane.

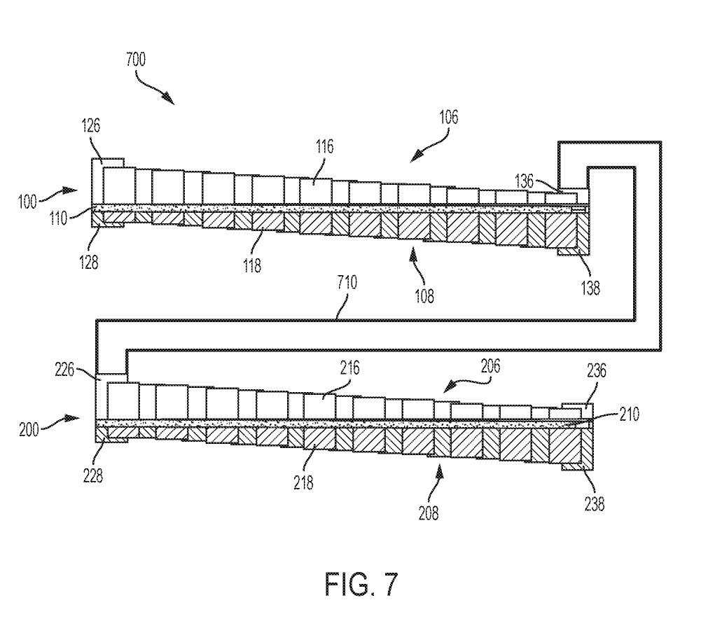

According to embodiments of the present disclosure a system including a plurality of TFF assemblies as described herein is also provided, wherein the plurality of TFF assemblies are connected in series. As shown in FIG. 7, the system 700 includes a first TFF assembly 100 and a second TFF assembly 200. The first TFF assembly 100 includes the features as described above and as illustrated in FIG. 4. Similarly, the second TFF assembly 200 includes a first filtration module 206 having a winding tangential flow channel 216 and a second filtration module 208 having a winding tangential flow channel 218. The first filtration module 206 includes an inlet 226 and an outlet 236 each fluidly connected to the winding tangential flow channel 216 at opposite endpoints of the winding tangential flow channel 216. Similarly, the second filtration module 208 includes an inlet 228 and an outlet 238 each fluidly connected to the winding tangential flow channel 218 at opposite endpoints of the winding tangential flow channel 218. The height of the winding tangential flow channels 216, 218 is variable and the winding tangential flow channels 216, 218 have an initial cross-sectional area at the respective inlet 226, 228 and a final cross-sectional area at the respective outlet 236, 238. According to embodiments of the present disclosure, the initial cross-sectional area of winding tangential flow channel 216 is greater than the final cross-sectional area of the winding tangential flow channel 216 and the cross-sectional area of tangential flow channel 216 reduces along the length of the channel from the inlet 226 to the outlet 236. Additionally, according to embodiments of the present disclosure, the initial cross-sectional area of winding tangential flow channel 218 is less than the final cross-sectional area of the winding tangential flow channel 218 and the cross-sectional area of tangential flow channel 218 increases along the length of the channel from the inlet 228 to the outlet 238.

As shown in FIG. 7, the system 700 includes a conduit 710 fluidly connecting the first TFF assembly 100 to the second TFF assembly 200. The exemplary system 700 is shown with the conduit 710 fluidly connecting outlet 136 of tangential flow channel 116 of first TFF assembly 100 with inlet 226 of tangential flow channel 216 of second TFF assembly 200. The system 700 of FIG. 7 shows two TFF assemblies 100, 200 connected in series. However, it should be appreciated that any number of TFF assemblies may be connected in series with a separate conduit 710 fluidly connecting one TFF assembly to a subsequent TFF assembly. Such a system includes “n” number of assemblies and “n-1” number of conduits.

Like the TFF assembly 100 as shown in FIG. 4, the second TFF assembly 200 includes a filtration membrane 210 positioned between, and separating, winding tangential flow channel 216 and winding tangential flow channel 218. The specific material and the specific pore size of the filtration membrane 210 may be selected based on the size of the solute species that will be removed by the TFF assembly 200. According to embodiments of the present disclosure, the pore size of filtration membrane 210 may be the same as the pore size of filtration membrane 110. Alternatively, the pore size of filtration membrane 210 may be different than the pore size of filtration membrane 110. The design of system 700 and the pore size of each of filtration membrane 110 and filtration membrane 210 may be varied depending on how the plurality of TFF assemblies 100, 200 are connected in series. For example, in the system 700 shown in FIG. 7, the permeate of the first TFF assembly 100 may flow from outlet 138 of tangential flow channel 118 through conduit 710 and into tangential flow channel 218 through inlet 226 of the second TFF assembly 200.

While the present disclosure includes a limited number of embodiments, those skilled in the art, having benefit of this disclosure, will appreciate that other embodiments can be devised which do not depart from the scope of the present disclosure.

What is claimed is:

1. A tangential flow filtration assembly comprising:
a first winding tangential flow channel comprising an inlet at an endpoint of the first tangential flow channel and an outlet at an opposite endpoint of the first tangential flow channel, the first winding tangential flow channel further comprising a first cross-sectional area at the inlet and a second cross-sectional area at the outlet;
a second winding tangential flow channel comprising an inlet at an endpoint of the second tangential flow channel and an outlet at an opposite endpoint of the second tangential flow channel the second winding tangential flow channel fluffier comprising a first cross-sectional area at the inlet and a second cross-sectional area at the outlet; and
a filtration membrane positioned between the first and second tangential flow channels,
wherein the first cross-sectional area of the first tangential flow channel is greater than the second cross-sectional area of the first tangential flow channel, and
wherein the first cross-sectional area of the second tangential flow channels is less than the second cross-sectional area of the second tangential flow channel.

2. The tangential flow filtration assembly of claim 1, wherein transmembrane velocity is substantially constant along the length of the first and second tangential flow channels.

3. The tangential flow filtration assembly of claim 1, wherein transmembrane pressure is substantially constant along the length of the first and second tangential flow channels.

4. The tangential flow filtration assembly of claim 1, wherein the filtration membrane comprises a porous material.

5. The tangential flow filtration assembly of claim 1, wherein the filtration membrane comprises a first surface and a second surface, and wherein fluid in the first tangential flow channel flows tangentially over the first surface of the filtration membrane and fluid in the second tangential flow channel flows tangentially over the second surface of the filtration membrane.

6. The tangential flow filtration assembly of claim 1, wherein the filtration membrane comprises two filtration sheets arranged on either side of a porous material.

7. The tangential flow filtration assembly of claim 1, wherein when a transmembrane pressure is applied across the filtration membrane, a species of interest passes from a fluid in the first tangential flow channel through the filtration membrane and into a fluid in the second tangential flow channel.

8. The tangential flow filtration assembly of claim 7, wherein the filtration membrane comprises a porous material, and wherein the species of interest is smaller than the pores of the filtration membrane.

9. The tangential flow filtration assembly of claim 1, wherein when a transmembrane pressure is applied across the filtration membrane, species other than a species of interest pass from a fluid in the first tangential flow channel through the filtration membrane and into a fluid in the second tangential flow channel.

10. The tangential flow filtration assembly of claim 9, wherein the filtration membrane comprises a porous material, and wherein the species of interest is larger than the pores of the filtration membrane.

11. A tangential flow filtration system comprising:
a plurality of tangential flow filtration assemblies; and
at least one conduit fluidly connecting one of the plurality of tangential flow filtration assemblies to a subsequent assembly of the plurality of tangential flow filtration assemblies, the system comprising n-1 conduits, wherein n is the number of tangential low filtration assemblies in the plurality of tangential flow filtration assemblies, and
wherein each tangential flow filtration assembly comprises:
a first winding tangential flow channel comprising an inlet at an endpoint of the first tangential flow channel and an outlet at an opposite endpoint of the first tangential flow channel, the first winding tangential flow channel further comprising a first cross-sectional area at the inlet and a second cross-sectional area at the outlet;
a second winding tangential flow channel comprising an inlet at an endpoint of the second tangential flow channel and an outlet at an opposite endpoint of the second tangential flow channel the second winding tangential flow channel further comprising a first cross-sectional area at the inlet and a second cross-sectional area at the outlet; and
a filtration membrane positioned between the first and second tangential flow channels,
wherein the first cross-sectional area of the first tangential flow channel is greater than the second cross-sectional area of the first tangential flow channel, and
wherein the first cross-sectional area of the second tangential flow channels is less than the second cross-sectional area of the second tangential flow channel.

12. The tangential flow filtration system of claim 11, wherein the at least one conduit fluidly connects an outlet of one of the plurality of tangential flow filtration assemblies to an inlet of a subsequent assembly of the plurality of tangential flow filtration assemblies.

13. The tangential flow filtration system of claim 11, wherein transmembrane velocity is substantially constant along the length of the first and second tangential flow channels of each of the plurality of tangential flow filtration assemblies.

14. The tangential flow filtration assembly of claim 11, wherein transmembrane pressure is substantially constant along the length of the first and second tangential flow channels of each of the plurality of tangential flow filtration assemblies.

15. The tangential flow filtration system of claim 11, wherein the filtration membrane of each of the plurality of tangential flow filtration assemblies comprises a porous material.

16. The tangential flow filtration system of claim 11, wherein the filtration membrane of each of the plurality of tangential flow filtration assemblies comprises a first surface and a second surface, and wherein fluid in the first tangential flow channel flows tangentially over the first surface of the filtration membrane and fluid in the second tangential flow channel flows tangentially over the second surface of the filtration membrane.

17. The tangential flow filtration system of claim 11, wherein the filtration membrane of each of the plurality of tangential flow filtration assemblies comprises two filtration sheets arranged on either side of a porous material.

18. The tangential flow filtration system of claim 11, wherein when a transmembrane pressure is applied across the filtration membrane of the plurality of tangential flow filtration assemblies, a species of interest passes from a fluid in the first tangential flow channel through the filtration membrane and into a fluid in the second tangential flow channel.

19. The tangential flow filtration system of claim 18, wherein the filtration membrane comprises a porous material, and wherein the species of interest is smaller than the pores of the filtration membrane.

20. The tangential flow filtration system of claim 11, wherein when a transmembrane pressure is applied across the filtration membrane of the plurality of tangential flow filtration assemblies, species other than a species of interest pass from a fluid in the first tangential flow channel through the filtration membrane and into a fluid in the second tangential flow channel.

21. The tangential flow filtration system of claim 20, wherein the filtration membrane comprises a porous material, and wherein the species of interest is larger than the pores of the filtration membrane.

22. The tangential flow filtration system of claim 11, wherein the filtration membrane of each of the plurality of tangential flow filtration assemblies comprises a porous material, and wherein the pore size of the filtration membrane of at least one of the plurality of tangential flow filtration assemblies is different than the pore size of the filtration membrane of a subsequent assembly of the plurality of tangential flow filtration assemblies.

23. The tangential flow filtration system of claim 22, wherein the pore size of the filtration membrane of at least one of the plurality of tangential flow filtration assemblies is larger than the pore size of the filtration membrane of a subsequent assembly of the plurality of tangential flow filtration assemblies.
